(19) United States
(12) Patent Application Publication
(10) Pub. No.: US 2009/0326117 A1
(43) Pub. Date: Dec. 31, 2009

(54) Intumescent Seal

(76) Inventors: Giampaolo Benussi, Brescia (IT); Guido Niederjaufner, Brescia (IT); Gianfranco Sai, Darzo (IT)

Correspondence Address: Themis Law, 7660 Fay Ave Ste H-535, La Jolla, CA, 92037, US

(21) Appl. No.: 11/915,382

(22) PCT Filed: May 29, 2006
(86) PCT No.: PCT/IB2006/051696

§ 371 Date: Nov. 25, 2007

(30) Foreign Application Priority Data
May 27, 2005 (IT) VI2005A000160

(51) Int. Cl. C08K 5/55

(52) U.S. Cl. 524/183

(57) ABSTRACT

A flexible intumescent seal for passive fire protection has a base material that consists of a blend comprising at least one thermoplastic polymer, expandable graphite and at least one acid generating compound. The acid generating compound is an organic boron compound and the at least one thermoplastic polymer is a vinyl polymer and/or copolymer. The seal may be formed by extrusion, drawing, molding or injection of the blend.

### FIELD OF THE INVENTION

This invention relates to a flexible seal formed of intumescent material, for use in strip or extruded form on fire resistant door and window frames.

Such door and window frames may be part of fire retardant structures or barriers for passive fire protection.

### BACKGROUND ART

According to the latest fire prevention criteria, buildings are divided into sections or compartments which are separated by fire retardant barriers having the dual purpose of preventing fire from spreading to unaffected places, and of extinguishing fire by removing the required combustion air.

Therefore, door and window frames of such fire retardant systems or barriers shall prevent the spreading of both flames and hot smoke originating from combustion to other parts of the building. Such smoke may be toxic and generate further sources of fire ignition.

To this end, such door and window frames are fitted with so-called intumescent seals, which swell when heated, thereby sealing any slits in such frames, during a fire.

With the term “intumescent” it is meant the property of a material to expand under heat, and to form a porous, insulating and substantially incombustible structure.

When heated, the intumescent composition does not melt and burn, but it forms a relatively strong carbon foam which acts as a barrier against gases and heat.

For such sealing to be effective, the expanded seal shall remain in position and resist to all mechanical stresses acting thereupon due to fire.

Seals shall also maintain their mechanical elasticity and resistance substantially constant with time even in normal conditions of use, to allow both easy fitting of the seal on the frame and stable anchorage thereof, for at least about ten years.

EP-A-949313 discloses an intumescent seal obtained from an aqueous suspension of acrylic latex, mineral fibers (mineral wool) and expandable graphite, using a process similar to a paper-making process.

One drawback of this prior art material is that it requires a wet process, using large amounts of water to be removed by compression and drying. Furthermore, the seal so obtained is partly non-cohesive and requires a support on which adhesive has to be deposited.

EP-A-1132563 discloses a seal composed of a sheath, normally acting as a cold gas seal, which in turn contains an intumescent composition that, in case of fire, acts as a hot gas seal, the latter being composed of copolymers selected from SBS, styrene-isoprene-styrene, polyether, PU-polyether and preferably containing methacrylic acid molecules in a random distribution, expandable graphite and/or vermiculite, ammonium polyphosphate and a mixture of acid oxides (such as Si₂, P₂O₅) and basic oxides (such as K₂O, Na₂O, ZnO, CaO), preferably in the form of kaolinites. In case of fire, the mixture forms a porous and expanded ceramic-like structure.

Drawbacks of this prior art seal are that it is poorly flexible and subjected to cracks, that it has to be packaged in coils with a large-diameter spool, and that it needs a support for attachment. EP-B-839171 discloses an intumescent sealant consisting of a polymeric binder, normally used as a “hot melt” adhesive, comprising PE, ethylene-acrylate copolymers, ethylene vinyl acetate, polyamides, PU, polyesters, mineral fibers, expandable graphite, inorganic flame-retardant compounds and a thermosetting resin, such as a phenol-formaldehyde resin, as a component for forming the expanded charred structure.

One drawback of this prior art sealant is that it cannot be easily shaped into strips, wherefore it has to be used in the molten state, and directly placed on the door or window frame by suitable dispensing machines.

EP-A-879870 discloses a blend for preparing an intumescent seal comprising an elastomeric thermoplastic polymer or ethylene vinyl acetate, a phosphorous compound as a flame retardant agent, preferably a phosphoric ester, and expandable graphite. The blend may further contain inorganic fillers, such as aluminum oxide or magnesium hydrate oxide, mica, vermiculite or other silicates and inorganic fibers,

EP-B-1207183 discloses an intumescent blend, composed of a thermoplastic polymer, such as an ethylene vinyl acetate copolymer, a phosphorous compound as a flame retardant agent and at least two types of expandable graphite, having different properties, such as expanding temperatures and volumes.

EP-A-1498463 discloses an intumescent seal composed of an ethyl vinyl acetate copolymer having an acetate content of 6 to 40% by weight, a phosphorous compound as a flame retardant agent and expandable graphite.

From JP2005-126458 is known a flexible intumescent seal having all the features of the preamble of the claim 1.

### SUMMARY OF THE INVENTION

The main object of this invention is to obviate the above drawbacks by providing an intumescent seal having high mechanical elasticity and resistance to normal environment conditions, which is obtained by a solution different from those described above.

A particular object is to provide a seal having high expansibility and resistance to fluid dynamic stresses caused by a fire.

A further particular object is to provide a seal allowing strong adhesion to door or window frames even during a fire.

Yet another object of this invention is to provide an intumescent seal that Is inexpensive and highly reliable in operation.

These and other objects, as better explained hereafter, are fulfilled by a flexible intumescent seal for passive fire protection according to claim 1.

Such thermoplastic polymers are vinyl polymers and/or copolymers comprising one or more groups:

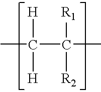

where R1 is: H or CH₃; and

R₂ is:

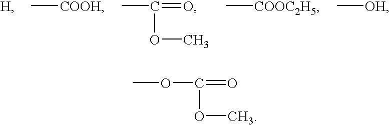

This acid generating compound is an organic boron compound of type:

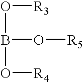

where: R₃, R₄ and R₅ are independently H or a linear or branched C₁-C₅ hydrocarbon chain or R₃ and R₄ are simultaneously H and R₅ is melamine (1,3-5-triazins-2,4,6-triamines) or ammonium pentaborate.

Thanks to this seal, which remains in position and seals doors or windows even under strong positive or negative pressures, the risk of smoke and/or fire spreading among the various parts of a building is considerably reduced.

### BRIEF DESCRIPTION OF THE DRAWINGS

Further features and advantages of the invention will be more readily apparent from the detailed description of a few preferred non exclusive embodiments of a seal according to the invention, which is shown as a non limiting example with the help of the annexed figures, in which:

FIG. 1 is a schematic sectional view of an oven for testing intumescent seals;

FIG. 2 is a schematic axonometric view of the opening of the oven of FIG. 1;

FIG. 3 shows the thermocouple positioning pattern on a door or window frame for fire resistance tests.

### DETAILED DESCRIPTION OF ONE PREFERRED EMBODIMENT

The seal according to the invention is suitable for use in any kind of frames, such as doors, windows, door windows, roof windows, glazing panels, fireproof fan shutters but also in openings for the passage of cables, pipes, ventilation ducts or else, to seal each part of a building in the event of a fire.

The present intumescent seal may be manufactured by extrusion of a polymer mixture having thermoplastic properties, followed by at least one passage into a calendar for proper thickness definition or by using an injection press, drawing, molding, such processes and equipment being known to those of ordinary skill in the art.

The polymer mixture having thermoplastic properties contains one or more thermoplastic polymers, expandable graphite and at least one compound having the ability to decompose and generate an acid when exposed to high temperatures.

Expandable graphite, well known to those skilled in the art, is natural graphite, of which it retains the typical “flake” form, in whose lamellar structure an intercalant ion is introduced, by treatment with strong mineral acids in an oxidizing environment. At high temperatures, the intercalant ion reacts with carbon thereby generating a large amount of gas compounds, which open the graphite flakes apart, and produce the typical worm shape.

After treatment with acid, graphite may be washed to remove excess acid, which is possibly neutralized by alkalis. Depending on its treatment, graphite may be acid (with free, non intercalant, residual acid), neutral or basic, with alkalis remaining from the neutralization treatment. Once again, in the latter case, expansion is caused by the acid-derived intercalant anion.

Expandable graphite is sold by a number of suppliers (e.g. UCAR, Kropfmühl, Kaisersberg, NGS, Nyacol) in many types, differing from each other in terms of “flake” size, start expansion temperature, and specific volume, expressed in cm³ per gram of graphite, achieved after expansion.

The selection of the supplier and type of graphite are within the reach of those of ordinary skill in the art.

According to the invention, the expandable graphite is contained in the seal in an amount of 10% to 50% by weight and preferably of 25% to 35% by weight.

Still according to the invention, a single type of expandable graphite may be preferably used, although without limitation, which has a specific expansion of more than 250 cm³ per gram at 1000C.

As is known, thermoplastic polymers are polymers that are in pasty form when heated to more than 80° C. and become solid when cooled. They are generally processed by drawing them through a die to obtain a product of indefinite length and constant section or by using a molding press to obtain products of predetermined shapes.

The acid precursor or generating compound is a compound, generally a salt or an ester of a mineral acid, which can decompose at moderate temperatures, e.g. from 250° C. to 450° C., thereby releasing the corresponding acid.

Common acid generating compounds used in polymer mixtures that are to withstand high temperatures are ammonium phosphate, generally in the polymeric polyphosphate form, phosphoric acid esters, such as triphenyl ester, melamine phosphate.

From about 100° C. to about 400° C., depending on the degree of polymerization, ammonium phosphate decomposes to the phosphate ion and ammonia.

According to this invention, the mixture of thermoplastic polymers comprises at least one vinyl polymer.

Vinyl polymers according to the invention are polymers or copolymers whose polymer chain also contain the following group

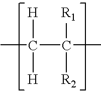

where R₁ is hydrogen or methyl and R₂ may be hydrogen, the carboxy group —COOH (acrylates), the hydroxy group —OH, the acetic group —CH₃COO, the group —CH₃COO, (methacrylates), the group —COOC₂H₅ (ethyl acrylates).

According to the invention, the vinyl polymers used preferably include HDPE, LDPE, PE, EVA, PVAC, PVAL, PM and/or mixtures thereof.

Suitably, the vinyl polymer is polyethylene vinyl acetate (EVA) having an acetate content of 20% to 50% by weight.

Several vinyl polymers may be used at the same time, including PE (polyethylene) and PVA (polyvinyl acetate). In this case, the acetate content will be related to the total of vinyl polymers in use.

At temperatures above 400° C., the acetic group is expelled, thereby leaving an unsaturation, wherefrom cyclization reactions are initiated, which are themselves catalyzed by the presence of mineral acid, and lead to the production of a carbon compound which is stable at high temperatures.

A boron compound is intended as a boron-containing compound. This may be of inorganic or organic nature.

In accordance with a preferred embodiment, the inorganic boron compound is an ammonium salt, such as ammonium pentaborate.

On organic boron compound is intended as a compound in which boron is bonded to at least one organic group, such as esters of boric acid[[.]],

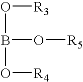

where the substituents R3, R4, R5 may be independently hydrogen or a linear or branched hydrocarbon chain containing up to 5 carbon atoms (C1-C5).

Particularly preferred compounds are those in which the substituents R₃, R₄, R₅ are a chain containing four identical carbon atoms, such as tributyl borates and triisopropyl borates.

According to another preferred embodiment, R₃ and R₄ are hydrogen and R₅ is melamine (1,3,5-triazins-2,4,6-triamines): the organic boron compound is melamine borate.

According to this preferred embodiment, the organic boron compound decomposes thereby forming an acid borate compound and gaseous melamine, which assists both the expansion of the charred structure and the spongy formation thereof, which structure is responsible to a significant extent for the thermal insulation properties of the expanded intumescent structure.

To enhance gas development, as is known to those skilled in the art, melamine and/or another gas developing compound may be added, which are preferably of the nitrogenous type to avoid the formation of fuel gases.

Advantageously, the mixture for making the intumescent seal may contain vinyl polymer in an amount of 30% to 60% by weight with respect to the final blend, preferably of 35% to 45% by weight, still with respect to the final blend, and the organic boron compound in an amount of 1% to 40% by weight and preferably of 2% to 25% by weight.

Up to 20% by weight of HDPE or LDPE or a mixture thereof may be added as an adjuvant to obtain a finished product with optimized mechanical properties, as is known to those of ordinary skill in the art.

Since organic boron compounds are soluble in vinyl polymers, effective results are obtained by mixing during extrusion: as a result, reagents for pyrolysis are evenly distributed, and the charred structure obtained thereby is particularly hard and persistent.

The composition of the invention obviates the drawbacks associated by prior art seal formulations.

In addition to the above compounds, the blend for making the seal of this invention may further contain ammonium polyphosphate in amounts of 1% to 30% by weight, preferably of 2% to 25% by weight. As is known, ammonium polyphosphate decomposes at temperatures above 350° C. in gaseous ammonia, which contributes to intumescence, and phosphoric acid which contributes to catalysis for forming a stable charred structure.

Since ammonium phosphate decomposes at relatively low temperatures, about 100° C., which are too low to initiate the cyclization process, a proper charred structure may be only formed by using ammonium polyphosphate, preferably with a chain having a molecular weight of more than 1000 units, which decomposes at temperatures above 350° C.

Furthermore, polyphosphate chains, which are scarcely movable in the polymer and substantially insoluble in water, limit migration of the polyphosphate from the inside to the surface and washout when the seal is exposed to or used in high moisture conditions, as well as degradation of expansion properties.

Washout and degradation may be further limited by using ammonium polyphosphate particles pre-coated with the vinyl polymers and polyolefins, to protect the polyphosphate from moisture.

An ammonium polyphosphate pre-coated with a formaldehyde melamine-based thermosetting resin is particularly suitable therefor.

In accordance with another preferred embodiment, the ammonium polyphosphate may be silanized to enhance compatibility with the polymer matrix, thereby promoting deacetylation and cyclization of acetate.

According to the invention, this produces a particularly stable and ceramic-like expanded charred structure, which requires no addition of carbon generating substances and/or inorganic glass structure forming substances.

In addition, the seal of this invention may contain a small amount of hydrated aluminum oxide and/or hydrated magnesium oxide, in amounts of 1% to 30% by weight and preferably of 1% to 6% by weight.

When heated, both substances release water of crystallization, thereby absorbing great amounts of heat.

In addition to the above components other components may be obviously provided, which are ordinarily used in plastics industry and are known to those skilled in the art, such as UV stabilizers, e.g. carbon black, in amounts of 1% to 3% by weight, antioxidants, e.g. IRGANOX 1010® (CIBA) in amounts of less than 1%, inorganic fillers such as calcium carbonate, mica, talc, kaolinite in amounts of not more than 30%, without departure from the scope of the invention.

To facilitate installation of the seal, suitable attachment means may be provided on a flat face thereof, such as a layer of adhesive material.

For such attachment to be effective and resist, at normal environment conditions, for at least ten years, the adhesive shall be partly soluble and adhere to the polymer matrix of the seal, while contributing to the formation of the charred structure in the event of a fire.

Acrylic polymer and polyethyl vinyl acetate adhesives are particularly suitable.

### Example 1

A 16 mm corotating twin-screw extruder is fed by dosers (Brabender Twin-Screw) with 400 g/h of EVA, 3 melt index, with 40% acetate, 300 g/h of neutral expandable graphite (NGS), 250 g/h of melamine borate, 50 g/h of ammonium polyphosphate, 50 g/h of hydrated aluminum oxide, 1 g/h of carbon black, thereby obtaining a 2 mm thick and 30 mm wide web. Intumescent properties are determined by measuring the expansion ratio, i.e. the ratio between the final height and the initial height of a 50 mm diameter sample which is placed in a muffle furnace at 350° C., 450° C. and 550° C. respectively for 30 minutes.

In such measurements, the sample is placed on the bottom of a steel cylinder of identical diameter. Measurements were carried out both with the sample being free to expand (free expansion), and with the sample expanding against a 100 g weight placed thereon (expansion under load). The results are reported in Table 1.

TABLE 1

| Temperature | Free expansion ratio | Expansion ratio under load |
|---|---|---|
| 350° C. | 19 | 14 |
| 450° C. | 23 | 16 |
| 550° C. | 27 | 18 |

The only applicable European standard is a DIBt guideline (Deutsches Institut fur Bautechnik, Zulassungsgrundsätze fur dämmschichtbildende Baustoffe) which requires an expansion ratio under load at 450° C. above 5.7.

### Examples 2-15

Using the extruder and the measuring system of Example 1, seals were prepared from the blends reported in Tables 2, 3 and 4, and were tested, providing the expansion results indicated in such tables. In these tables, the vinyl acetate-containing polymers are conveniently characterized by two numbers, the melt index (MI), in accordance with ASTM, and the vinyl acetate content in percent. For example, 3/40 indicates a 3 Melt Index and 40% vinyl acetate.

The expandable graphite used in the following examples was sold by: Faima (Milan, Italy), UCAR (USA), NGS (Germany).

TABLE 2

| | Example | | | | |
|---|---|---|---|---|---|
| | 2 | 3 | 4 | 5 | 6 |
| EVA 7/28 | | | | | |
| EVA 3/40 | 35 | 35 | 40 | 40 | |
| EVA 50/50 | | | | | |
| EVA 50/80 | | | | | |
| PVA | | | | | |
| LDPE | | | | | |
| HDPE | | | | | |
| Neutral expandable | 35 | | 25 | 29 | 30 |
| graphite | | | | | |
| Acid expandable | | 29 | | | |
| graphite | | | | | |
| Melamine borate | 5 | 33 | 17 | 5 | 2 |
| Ammonium | | | 10 | | |
| pentaborate | | | | | |
| Triisopropyl borate | | | | | |
| Ammonium | 20 | | 5 | | 25 |
| polyphosphate | | | | | |
| Ammonium | | | | 22 | |
| polyphosphate | | | | | |
| coated with | | | | | |
| melamine resin | | | | | |
| Silanized ammonium | | | | | |
| polyphosphate | | | | | |
| Melamine phosphate | | | | | |
| Hydrated | 2 | 2.5 | | | 2.5 |
| aluminum oxide | | | | | |
| Hydrated | 2 | | 2.5 | 3 | |
| magnesium oxide | | | | | |
| Carbon black | 1 | 0.5 | 0.5 | 1 | 0.5 |
| Free expansion ratio | | | | | |
| 350° C. | 17 | 19 | 15 | 16 | 18 |
| 450° C. | 20 | 22 | 18 | 25 | 24 |
| 550° C. | 21 | 24 | 20 | 29 | 28 |
| Expansion ratio | | | | | |
| under load | | | | | |
| 350° C. | 11 | 13 | 9 | 12 | 14 |
| 450° C. | 15 | 16 | 11 | 15 | 15 |
| 550° C. | 15 | 16 | 14 | 20 | 18 |

TABLE 3

| | Example | | | | | |
|---|---|---|---|---|---|---|
| | 7 | 8 | 9 | 10 | 11 | 12 |
| EVA 7/28 | 45 | 38 | | | 15 | 20 |
| EVA 3/40 | | | 40 | 35 | | |
| EVA 50/50 | | | | | | 20 |
| EVA 50/80 | | | | | 20 | |
| PVA | | | | | | |
| LDPE | | | | 10 | | 5 |
| HDPE | | | | | 5 | |
| Neutral expandable graphite | | 29 | 30 | 28 | 31 | 25 |
| Acid expandable graphite | 25 | | | | | |
| Melamine borate | 22 | | | 5 | 21 | 5 |
| Ammonium pentaborate | | | 15 | | | |
| Triisopropyl borate | | 20 | | | | |
| Ammonium | 5 | 8 | 10 | 19 | 5 | |
| polyphosphate | | | | | | |
| Ammonium | | | | | | |
| polyphosphate | | | | | | |
| coated with | | | | | | |
| melamine resin | | | | | | |
| Silanized ammonium | | | | | | 22 |
| polyphosphate | | | | | | |
| Melamine phosphate | | | | | | |
| Hydrated | 2.5 | | | 2 | 2 | |
| aluminum oxide | | | | | | |
| Hydrated | | 4.5 | 4.5 | | | 2.5 |
| magnesium oxide | | | | | | |
| Carbon black | 0.5 | 0.5 | 0.5 | 1 | 1 | 0.5 |
| Free expansion ratio | | | | | | |
| 350° C. | 15 | 8 | 19 | 15 | 20 | 13 |
| 450° C. | 17 | 11 | 25 | 19 | 24 | 16 |
| 550° C. | 21 | 15 | 29 | 20 | 24 | 20 |
| Expansion ratio | | | | | | |
| under load | | | | | | |
| 350° C. | 9 | 6 | 13 | 9 | 12 | 10 |
| 450° C. | 12 | 7 | 16 | 10 | 14 | 12 |
| 550° C. | 15 | 9 | 19 | 13 | 16 | 15 |

TABLE 4

| | Example | | | | | |
|---|---|---|---|---|---|---|
| | 13 | 14 | 15 | 16 | 17 | 18 |
| EVA 7/28 | 20 | 30 | 20 | | | 15 |
| EVA 3/40 | | | 20 | 39 | 30 | 25 |
| EVA 50/50 | | | | | | |
| EVA 50/80 | 20 | | | | 10 | |
| PVA | | 15 | | | | |
| LDPE | | | | | 10 | |
| HDPE | 5 | | | | | |
| Neutral expandable graphite | 27 | 30 | 33 | 30 | 27 | 30 |
| Acid expandable graphite | | | | | | |
| Melamine borate | 5 | 2 | 5 | 13 | | 27 |
| Ammonium pentaborate | | | | | | |
| Triisopropyl borate | | | | | | |
| Ammonium polyphosphate | | | 10 | | | |
| Ammonium polyphosphate | | 20 | | 15 | | |
| coated with melamine resin | | | | | | |
| Silanized ammonium | 20 | | | | | |
| polyphosphate | | | | | | |
| Melamine phosphate | | | 8 | | | |
| Hydrated aluminum oxide | | | | 2.5 | 2.5 | 2.5 |
| Hydrated magnesium oxide | 2.5 | 2 | 3 | | | |
| Carbon black | 0.5 | 1 | 1 | 0.5 | 0.5 | 0.5 |
| Free expansion ratio | | | | | | |
| 350° C. | 14 | 12 | 17 | 19 | 14 | 17 |
| 450° C. | 17 | 16 | 22 | 23 | 20 | 24 |
| 550° C. | 19 | 18 | 27 | 30 | 25 | 28 |
| Expansion ratio under load | | | | | | |
| 350° C. | 11 | 9 | 13 | 12 | 10 | 14 |
| 450° C. | 14 | 10 | 16 | 16 | 13 | 16 |
| 550° C. | 16 | 13 | 18 | 18 | 16 | 18 |

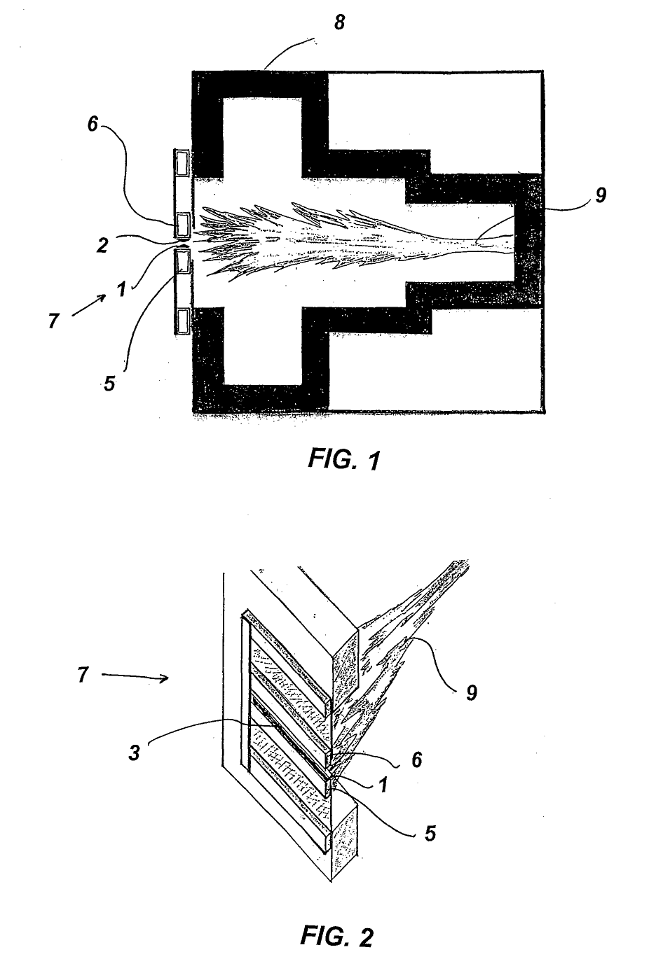

Referring to FIGS. 1 and 2, two intumescent sealing strips 1, 2 having a width of 20 mm and a height of 1.5 mm, extruded from the formulations of examples 1, 3, 6, 15, 16 have been placed on the edges 3, 4 of two frame profiles 5, 6 which are 20 mm apart, and the frame is placed on the opening 7 of a furnace 8. Once they have been invested by a flame 9, about 600 mm long, they have sealed the opening in less than 30 seconds and have maintained such sealing stable for more than 120 minutes.

Two fire doors, with the intumescent seals made from formulations 3 and 16 applied thereon in distinct sections, have been fire tested for validation according to the procedure of UNI EN 1634-1 standard.

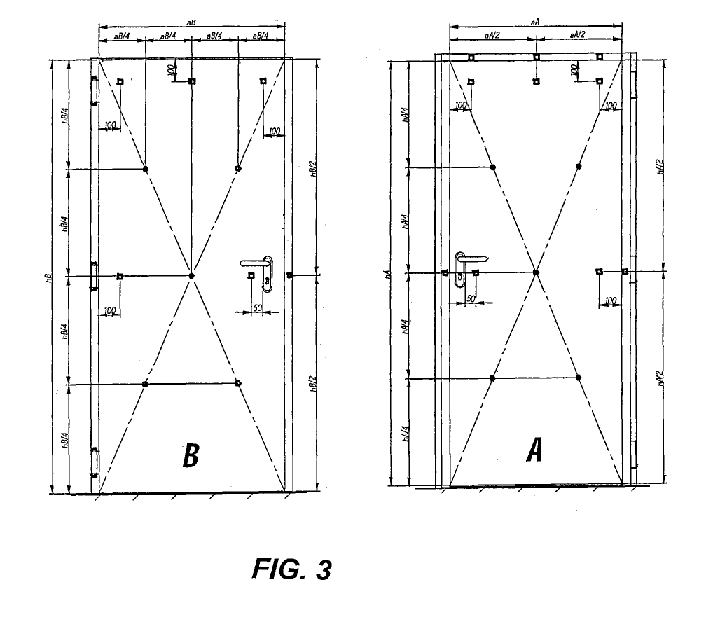

The annexed FIG. 3 shows the positions of thermocouples. For a predetermined time, depending on the desired classification (30, 60, 120, 180 minutes), the thermocouples should indicate a temperature increase of less than 180° C. on the door and of less than 360° C. on the frame.

The doors equipped with the above seals have exceeded a fire resistance time of 120 minutes. Particularly, the seal was able to entirely seal, without falling, even the opening that was formed after 80 minutes from the start of the test between the frame and the door, when the door was bent due to thermal expansion.

The intumescent seal of the invention is susceptible of a many changes and variants within the inventive principle disclosed in the annexed claims.

What is claimed is:

1. A flexible intumescent seal having a base material consisting of a blend comprising:
at least one thermoplastic polymer;
expandable graphite; and
at least one compound which decomposes at moderate temperature generating a corresponding acid,
wherein said acid generating compound is a boron compound,
wherein said at least one thermoplastic polymer is a vinyl polymer and/or copolymer, and
wherein said boron compound is selected from the group consisting of ammonium pentaborate, triisopropyl borate, tri-n-propyl borate, and melamine borate.

2. The Flexible intumescent seal as claimed in claim 1, wherein said at least one vinyl polymer and/or copolymer comprises one or more groups 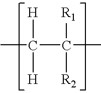
where R₁ is: H or CH₃; and
R₂ is:

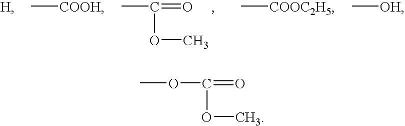

3. The flexible intumescent seal as claimed in claim 1, wherein said vinyl polymer is selected from the group consisting of HDPE, LDPE, PE, EVA, PolyVinyl Acetate, PolyVinyl Acetal, Poly Acryl Amide and mixtures thereof.

4. The flexible intumescent seal as claimed in claim 1, wherein said at least one vinyl polymer contains a total amount of vinyl acetate of about 20% to 50% by weight.

5. The flexible intumescent seal as claimed in claim 1, wherein said at least one vinyl polymer is contained in said blend in an amount of about 30% to 60% by weight and said boron compounds are contained in said blend in an amount of about 1% to 30% by weight based on the total weight of the composition.

6. The flexible intumescent seal as claimed in claim 1, wherein said blend further comprises a nitrogenous phosphoric acid compound, which can decompose in the event of fire, in an amount of about 1% to 30% by weight based on the total weight of the composition.

7. The flexible intumescent seal as claimed in claim 6, wherein said nitrogenous phosphoric acid compound is ammonium polyphosphate having a molecular weight of more than 1000 daltons or melamine phosphate.

8. The flexible intumescent seal as claimed in claim 7, wherein said ammonium polyphosphate is pre-coated with a polymer to limit water solubility.

9. The flexible intumescent seal as claimed in claim 8, wherein said ammonium polyphosphate is silanized to enhance compatibility with other components of the blend.

10. The flexible intumescent seal as claimed in claim 1, wherein said expandable graphite is contained in said blend in an amount of about 10% to 50% by weight based on the total weight of the composition.

11. The flexible intumescent seal as claimed in claim 1, further comprising at least one inorganic flame retardant compound selected from the group comprising hydrated aluminum oxide and hydrated magnesium oxide in amounts of about 1% to 30% by weight based on the total weight of the composition.

12. The flexible intumescent seal as claimed in claim 1, wherein said blend further comprises carbon black in an amount of about 0.3% to 3% by weight based on the total weight of the composition.

13. The flexible intumescent seal as claimed claim 1, wherein at least one surface of the flexible intumescent seal is configured for connection with a support structure for easy installation of the seal.

14. The flexible intumescent seal as claimed in claim 13, wherein a polyethylene vinyl acetate-based adhesive provides for the attachment to said support structure.

15. The flexible intumescent seal as claimed in claim 1, wherein the flexible intumescent seal is formed by extrusion, drawing, molding or injection of said blend.

16. A fire-resisting door or window frame comprising:
a flexible intumescent seal having a base material comprising a blend of at least one thermoplastic polymer, expandable graphite, and at least one compound which decomposes at moderate temperature generating a corresponding acid,
wherein said acid generating compound is a boron compound,
wherein said at least one thermoplastic polymer is a vinyl polymer and/or copolymer, and
wherein said boron compound is selected from the group consisting of ammonium pentaborate, triisopropyl borate, tri-n-propyl borate, and melamine borate.
